(19) United States
(12) Patent Application Publication
(10) Pub. No.: US 2009/0045687 A1
(43) Pub. Date: Feb. 19, 2009

(54) Inertia permanent magnet generator unit

(76) Inventors: Shu Hi Yu, Taoyuan county (TW); Shiang Pao Huang, Taoyuan county (TW)

Correspondence Address: BIRCH STEWART KOLASCH & BIRCH, PO BOX 747, FALLS CHURCH, VA, 22040-0747, US

(21) Appl. No.: 11/889,554

(22) Filed: Aug. 14, 2007

(51) Int. Cl. H02K 21/26; H02K 1/17

(52) U.S. Cl. 310/154.01

(57) ABSTRACT

An inertia permanent-magnet generator unit includes a body containing a stator structure, multiple pairs of permanent magnets on the stator structure; a rotor structure in the body, a central shaft penetrating a center of the body; multiple rotor blades being disposed to the rotor structure; and multiple troughs with each disposed on a top of the rotor blade in relation to the stator structure; multiple copper coils winding in troughs on tops of those rotor blades; a weight disposed on a rotor blade; and the rotor structure rotating forwardly by inertia to cut magnetic lines of force of the permanent magnets to generate electricity.

### FIELD OF THE INVENTION

The present invention is related to a permanent magnet generator unit, and more particularly, to an inertia permanent magnet generator unit.

### BACKGROUND OF THE INVENTION

A rotary generator unit usually operates on a theory of electromotive conversion to create induced electromotive force in a form of sine waves by cutting magnetic line of force. According to power generator rule proposed by Michael Faraday, the electromotive force is in proportion to the changing ratio of magnetic field in a closed loop. Lenz followed to verify Faraday's viewpoint. Later in interpreting Lenz's Law, Maxwell pointed out that electromotive force is created to resist changes in magnetic field through opposing various variations of magnetic flux and that change in the magnetic field can be induced through changing the magnetic flux by moving a magnet towards or away from a coil or by rotating the coil.

That is, if the magnetic flux is changed by the stationary or rotating coil, an electromotive force may be induced in another type of coil while the conversion of the form of energy is done by having an inertia motion converted into energy for output through electromotive effects to convert mechanical energy into electric energy. Usually, the conversion is done by means of thermal or hydraulic power; however, either power consumes massive resources to fail the purpose of environmental protection.

Therefore, how to reclaim and reuse energy to generate electric power without adding any external energy for achieving dual purposes of being practical and environmental protection at the same time becomes the primary target in the development of power in future.

### SUMMARY OF THE INVENTION

The primary purpose of the present invention is to provide an inertia permanent-magnet generator unit that operates on applying an external force to rotate the body to drive by inertia rotor blades inside the body to rotate and generate induced electromotive force according to changed magnetic flux for achieving the purpose of outputting power.

Another purpose is to provide an inertia permanent-magnet generator unit that supplies power from the induction electromotive force generated inside the body to an electric appliance.

To achieve these purposes, the present invention related to an inertia permanent-magnetic generator unit is comprised of a body containing a stator structure and 2 (2n−1) pairs of permanent magnets with each pair comprised of an N-pole and an S-pole alternatively arranged on the stator structure; a rotor structure disposed inside the body, a central shaft penetrating through the center of the body for the rotor structure to revolve around the center of the body; multiple rotor blades being disposed externally to the rotor structure; 2 (2n−1) sets of troughs being provided on tops of those rotor blades in relation to the stator structure; multiple cooper coils winding those troughs disposed at tops of those rotor blades; and a weight placed on one of those rotor blades. Accordingly, when the body rotates, the rotor structure rotates forwardly by inertia to cut magnetic lines of force of the permanent magnet to generate power.

### BRIEF DESCRIPTION OF THE DRAWINGS

FIG. 1 is a sectional view of a preferred embodiment of the present invention.

FIG. 2 is a side view of a rotor structure in the preferred embodiment of the present invention.

FIG. 3 is a bird's view of the rotor structure in the preferred embodiment of the present invention.

FIG. 4 is a perspective view showing multiple copper coils winding multiple troughs in the preferred embodiment of the present invention.

FIG. 5 is a bird's view showing those copper coil swinding multiple troughs in the preferred embodiment of the present invention.

FIG. 6 is a schematic view showing an operating status of the preferred embodiment of the present invention.

FIG. 7 is a magnified view showing a local part of a central shaft in the rotor structure of the preferred embodiment of the present invention.

### DETAILED DESCRIPTION OF THE PREFERRED EMBODIMENTS

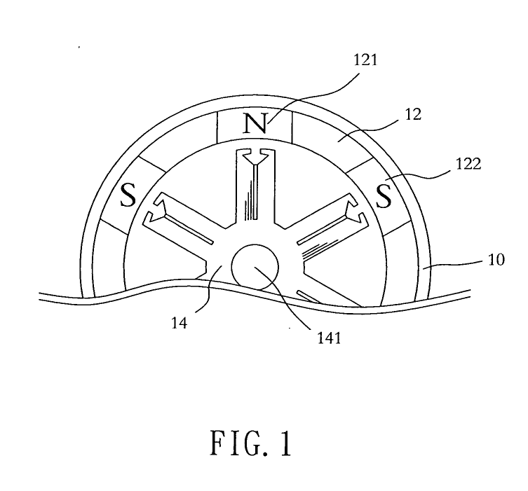

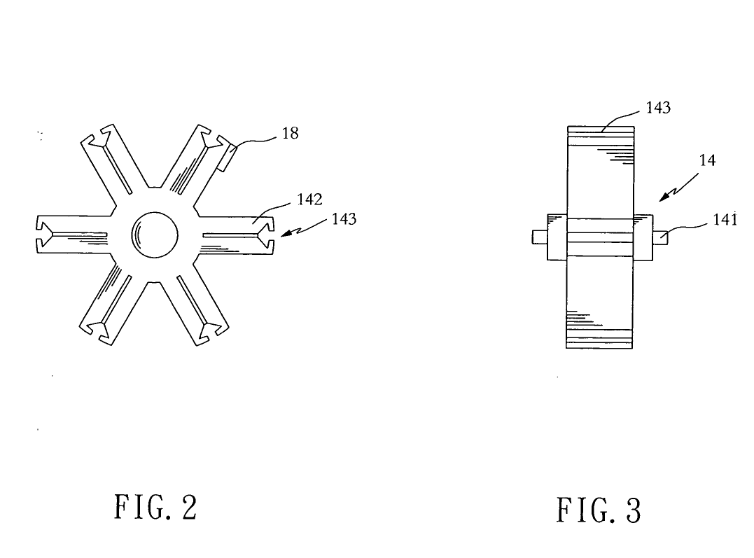

Referring to FIGS. 1, 2 and 3, an inertia permanent-magnet generator unit is comprised of a body 10 containing on an inner layer a stator structure 12; 2 (2n−1) pairs of permanent magnets with each pair comprised of an N-pole permanent magnet 121 and an S-pole permanent magnet 122, wherein n is related to a natural number; a rotor structure 14 disposed inside the body 10 with a central shaft 141 penetrating through a center of the body 10 for the rotor structure 14 to rotate around the center of the body 10; multiple rotor blades 142 are externally provided to the rotor structure 14 and 2 (2n−1) troughs 143 are disposed on tops of those rotor blades 142 at where in relation to the stator structure 12 and a gap between each rotor blade 142 and the stator structure 12 is not greater than 2.5 mm; and the body 10 can be made in any form as applicable.

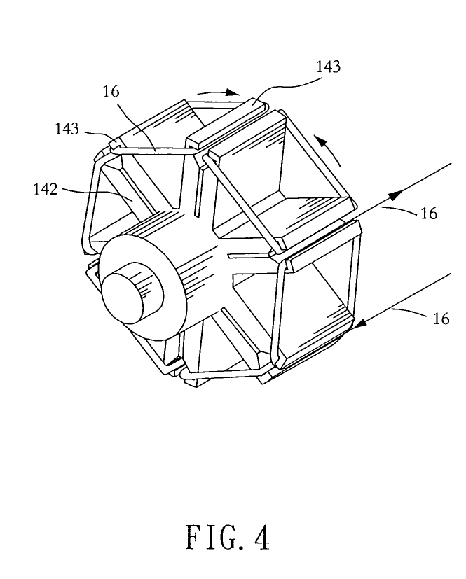

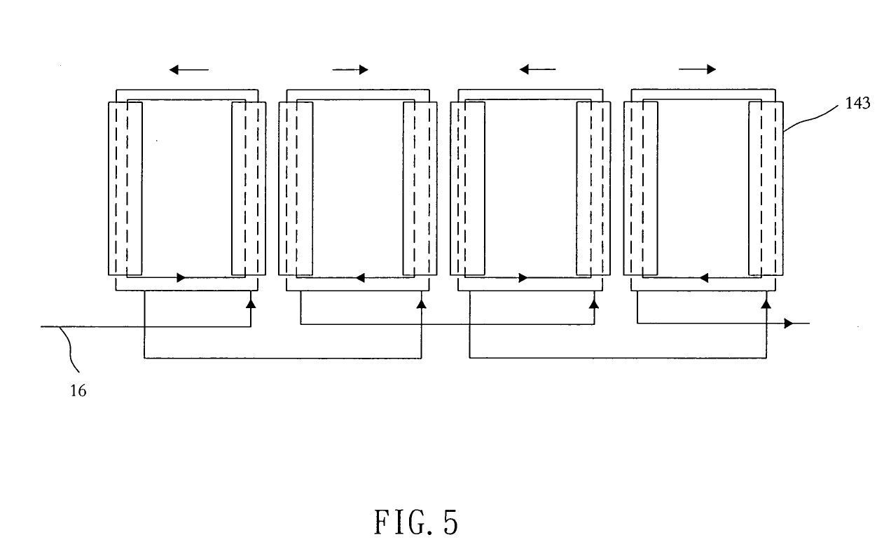

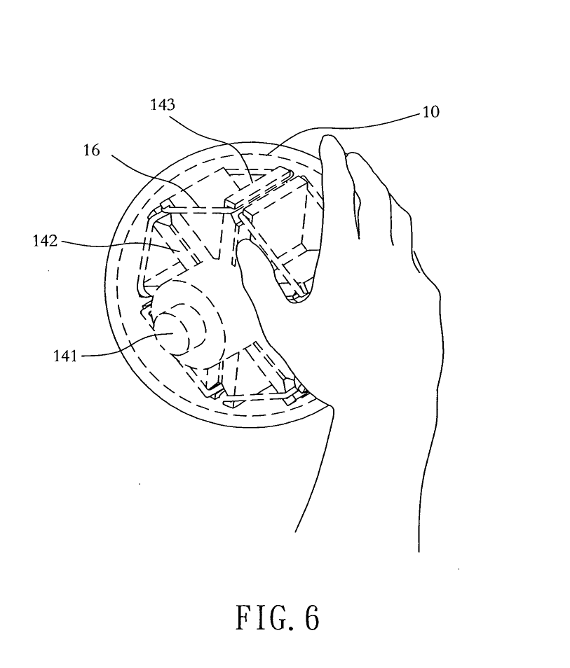

Now referring to FIGS. 4, 5, and 6, multiple copper coils 16 wind in those troughs 143 disposed at tops of those rotor blades 142 in sequence outwardly to where between any two abutted troughs 143; and a weight 18 is disposed on one of those rotor blades 142. When rotating the body 10 manually, the rotor structure 14 rotates forwardly by inertia to cut magnetic lines of force created by those N-pole permanent magnets 121 and S-pole permanent magnets 122 to generate electromotive force by opposition.

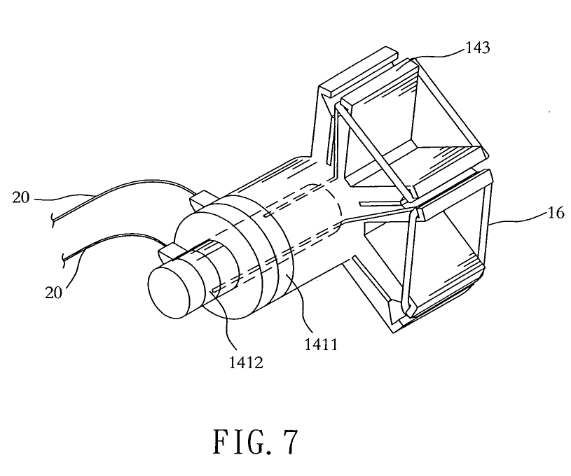

As illustrated in FIG. 7, a larger shaft 1411 and a smaller shaft 1412 are respectively provided to the central shaft 141 of the rotor structure 14 to connect a copper ring (collector ring) for connecting two metal cable 20 to those copper coils 16; an electromotive force is induced inside the body 10 directly supplies power to an electric appliance through the electromotive force outputted from the larger shaft 1411 and the smaller shaft 1412 for achieving the purpose of providing a fast and convenient power supply.

The prevent invention provides a structure of an inertia permanent magnet generator unit that has not been obvious at the time it was made to a person having ordinary skill in the art to which the subject matter of the invention pertains; that the present invention has not been published before; and that the present invention is progressive and practical to meet application elements for an invention; therefore, the application for an invention is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. An inertia permanent-magnet generator unit including
a body containing on its inner layer a stator structure, 2 (2n−1) pairs of permanent magnets with each pair including an N-pole and an S-pole alternatively arranged on the stator structure;
a rotor structure disposed in the body, a central shaft penetrating a center of the body, the rotor structure rotating around the center of the body, multiple rotor blades being disposed externally to the rotor structure; and 2 (2n−1) troughs with each being disposed on a top of the rotor blade at where in relation to the stator structure;
multiple copper coils winding in troughs on tops of those rotor blades; and
a weight disposed on one of those rotor blades; the rotor structure rotating forwardly by inertia when the body rotates to cut magnetic lines of force of the permanent magnets to generate electromotive force.

2. The inertia permanent-magnet generator unit as claimed in claim 1, wherein a gap between each rotor blade and the stator structure is not greater than 2.5 mm.

3. The inertia permanent-magnet generator unit as claimed in claim 1, wherein a larger shaft is further disposed to the central shaft of the rotor structure.

4. The inertia permanent-magnet generator unit as claimed in claim 1, wherein a smaller shaft is further disposed to the central shaft of the rotor structure.

5. The inertia permanent-magnet generator unit as claimed in claim 3, wherein a cooper ring (collector ring) is disposed to the central shaft of the rotor structure.

6. The inertia permanent-magnet generator unit as claimed in claim 4, wherein a cooper ring (collector ring) is disposed to the central shaft of the rotor structure.

7. The inertia permanent-magnet generator unit as claimed in claim 5, wherein a pair of metal cables are disposed to the central shaft of the rotor structure; and both metal cables are connected to the cooper ring (collector ring).

8. The inertia permanent-magnet generator unit as claimed in claim 6, wherein a pair of metal cables are disposed to the central shaft of the rotor structure; and both metal cables are connected to the cooper ring (collector ring).
